(19) United States
(12) Patent Application Publication
(10) Pub. No.: US 2016/0141141 A1
(43) Pub. Date: May 19, 2016

(54) FUSE UNIT

(71) Applicant: YAZAKI CORPORATION, Tokyo (JP)

(72) Inventors: Norihiro OHASHI, Shizuoka (JP); Norio MATSUMURA, Shizuoka (JP)

(73) Assignee: YAZAKI CORPORATION, Tokyo (JP)

(21) Appl. No.: 15/001,319

(22) Filed: Jan. 20, 2016

Related U.S. Application Data
(63) Continuation of application No. PCT/JP2014/067808, filed on Jul. 3, 2014.

(30) Foreign Application Priority Data
Jul. 23, 2013 (JP) 2013-152461

(51) Int. Cl. H01H 85/17; H01H 85/02; H01H 85/20

(52) U.S. Cl. CPC H01H 85/17; H01H 85/20; H01H 85/0241; H01H 2085/025; H01H 2231/026

(57) ABSTRACT

A fuse unit includes a fuse unit body and a holding member being a different member from the fuse unit body. The fuse unit body includes a conductive fuse element having a hinge and first and second resin bodies provided across the hinge, and the fuse unit body is bendable at the hinge. The holding member engages with the first and second resin bodies of the fuse unit body bent at the hinge and maintains the fuse unit body in a bent state.

### CROSS REFERENCE TO RELATED APPLICATION

This application is a Continuation of PCT Application No. PCT/JP2014/067808, filed on Jul. 3, 2014, and claims the priority of Japanese Patent Application No. 2013-152461, filed on Jul. 23, 2013, the content of both of which is incorporated herein by reference.

### BACKGROUND

1. Technical Field

The disclosure invention relates to a fuse unit.

2. Background Art

Japanese Unexamined Patent Application Publication No. 2002-289171 proposes a fuse unit 301 as illustrated in FIG. 1. The fuse unit 301 includes a bus bar 305 including a hinge 303, a first resin body 307 provided on a first side of the bus bar 305, and a second resin body 309 provided on a second side of the bus bar 305. The hinge 303 is placed between the first side and the second side.

The bus bar 305 is bent at the hinge 303 at a right angle so that the fuse unit 301 is formed into an L shape.

A seized portion provided on the first resin body 307 is seized on the seizing portion provided on the second resin body 309. This maintains the curve of the L shape.

Japanese Unexamined Patent Application Publication No. 2011-81912 proposes a fuse unit 351 as illustrated in FIGS. 2A and 2B. Similarly to the fuse unit 301, a seized portion 353 is seized on a seizing portion 355. This maintains an L shape of a bent fuse unit 351 (see FIG. 2B).

### SUMMARY

By the way, the resin body of the related fuse unit is made of synthetic resin having high heat resistance because it is necessary to enhance the heat resistance of the related fuse unit. The synthetic resin having high heat resistance has a tendency to be hard and brittle. The seizing portion (the engaging portion) and the seized portion (the engaged portion) are integrally formed with the resin body, so that the seizing portion and the seized portion are made of the same material as the resin body.

The seized portion of the related fuse unit is elastically deformed in the middle of forming the L shape by bending the bus bar at the hinge. The seized portion is restored when the bus bar is bent at a right angle and the L shape is formed. This seizes the seized portion on the seizing portion.

The seized portion, which is made of synthetic resin with high heat resistance, has a low tolerance to deformation when being elastically deformed. To increase the tolerance to deformation, the length of protrusion of the seized portion (for example, the elastic arm) can be increased. However, it is difficult to increase the seized portion in size because the fuse unit is placed and used in a narrow space, for example, between a vehicle and a battery body installed on the vehicle.

Accordingly, the low tolerance to deformation of the seized portion varies the holding force to maintain a shape such as the L shape when the bus bar is bent at the hinge and the fuse unit is formed into the L shape.

An object of the disclosure is to provide a fuse unit that has heat resistance and is used with the bus bar bent at the hinge, in which the holding force to maintain the bent shape can be prevented from varying without increasing the size of the fuse unit.

A fuse unit in accordance with some embodiments includes a fuse unit body and a holding member being a different member from the fuse unit body. The fuse unit body include: a conductive fuse element having a hinge, the fuse unit body being bendable at the hinge; a first resin body provided on a first side of the fuse element across the hinge; and a second resin body provided on a second side of the fuse element, the second side located opposite to the first side across the hinge. The holding member engages with the first resin body and the second resin body of the fuse unit body bent at the hinge and maintains the fuse unit body in a bent state.

The fuse unit body may include a first portion having a plate shape with a first thickness including a portion on the first side of the fuse element and the first resin body, and a second portion having a plate shape with a second thickness including a portion on the second side of the fuse element and the second resin body. The holding member may have a plate shape with a third thickness. Upon the bent state of the fuse unit body being maintained by the holding member, a thickness direction of the first thickness, a thickness direction of the second thickness, and a thickness direction of the third thickness may be perpendicular to each other, the first portion and the second portion may form an L shape when viewed in a direction in which the hinge extends, and the holding member may be engaged with the first portion and the second portion at a portion at a minor angle of intersection angles of the first portion and the second portion.

The holding member may include a first engaged portion and a second engaged portion. The first resin body may include a first engaging portion with which the first engaged portion engages. The second resin body may include a protrusion portion protruding in a direction identical to a direction in which the first portion extends and including a second engaging portion with which the second engaged portion engages. The holding member may be fixed on the fuse unit body with the first engaged portion engaged with the first engaging portion, the second engaged portion engaged with the second engaging portion, and the holding member linearly moved in the thickness direction of the second thickness.

The first engaging portion may include a first plate-shaped portion and an elongated first notch on the first plate-shaped portion. The second engaging portion may include a second plate-shaped portion and an elongated second notch on the second plate-shaped portion. The first engaged portion may include a portion having a cross-section of an H shape. The second engaged portion may include a portion having a cross-section of an H shape. The first engaged portion may engage with the first engaging portion with a portion that is a horizontal line of the H shape of the portion of the first engaged portion being inserted into the first notch and with portions that are a pair of vertical lines of the H shape of the portion of the first engaged portion holding the first plate-shaped portion between the vertical lines. The second engaged portion may engage with the second engaging portion with a portion that is a horizontal line of the H shape of the portion of the second engaged portion being inserted into the second notch and with portions that are a pair of vertical lines of the H shape of the portion of the second engaged portion holding the second plate-shaped portion between the vertical lines. The holding member may be fixed on the fuse unit body with the holding member linearly moved in an insertion direction along a longitudinal direction of the first notch and the second notch and a longitudinal direction of the H-shaped portions of the first engaged portion and the second engaged portion. A distance between the pair of vertical lines of the H shape of the portion of the second engaged portion may be gradually decreased toward the insertion direction.

According to the configuration described above, in the fuse unit that has heat resistance and is used with the bus bar bent at the hinge, the holding force to maintain the bent shape can be prevented from varying without increasing the size of the fuse unit.

### BRIEF DESCRIPTION OF DRAWINGS

FIG. 1 is a view of a related fuse unit.

FIG. 2A is a view of the related fuse unit.

FIG. 2B is a view of the related fuse unit.

FIG. 3 is a schematic perspective view of the configuration of the fuse unit body of a fuse unit according to an embodiment of the present invention.

FIG. 4 is a schematic perspective view of the configuration of the bent-state holding member of the fuse unit according to an embodiment of the present invention.

FIG. 5 is an elevation view of the fuse unit.

FIG. 6 is a view from VI of FIG. 5.

FIG. 7 is a cross-sectional view taken along VII-VII of FIG. 6.

FIG. 8 is a view from VIII of FIG. 6.

FIG. 9 is a perspective view of the fuse unit body before the hinge is bent.

FIG. 10A is a view from XA of FIG. 4.

FIG. 10B is a view from XB of FIG. 4.

FIG. 10C is a view from XC of FIG. 4.

FIG. 11A is a view from XIA of FIG. 4.

FIG. 11B is a view from XIB of FIG. 4.

FIG. 11C is a view from XIC of FIG. 4.

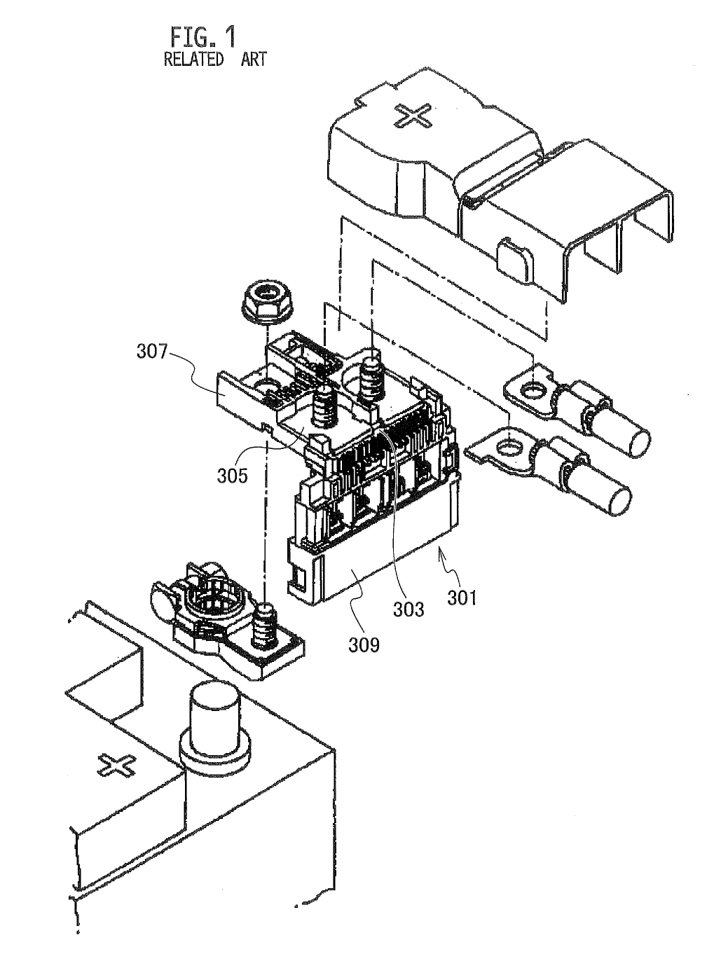

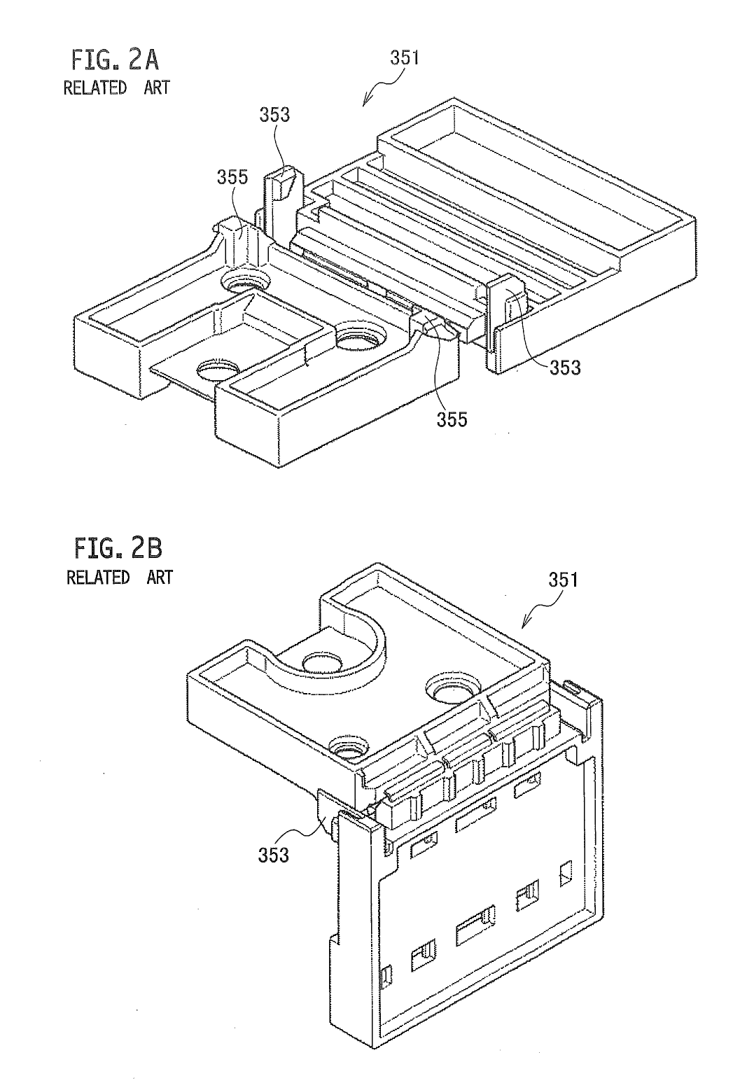

### DETAILED DESCRIPTION

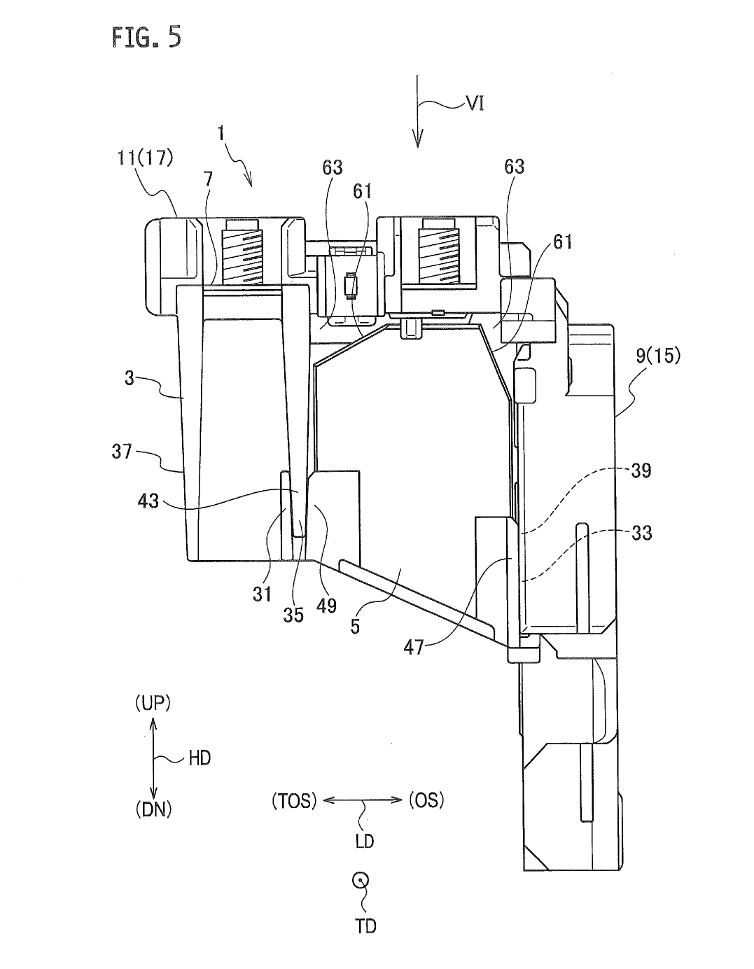

A fuse unit 1 according to an embodiment of the present invention is placed and used, for example, on a battery installed on a vehicle such as a car (not illustrated). The fuse unit 1 includes a fuse unit body 3 and a bent-state holding member (referred to also as a bent-state reinforcement member or a holding member) 5 as illustrated, for example, in FIG. 5. The height direction, longitudinal direction, and lateral direction are indicated as HD, LD, and TD, respectively, in the drawings. Furthermore, the upper side and lower side are indicated as UP and DN, and one end side and the other end side are indicated as OS and TOS, respectively, in the drawings.

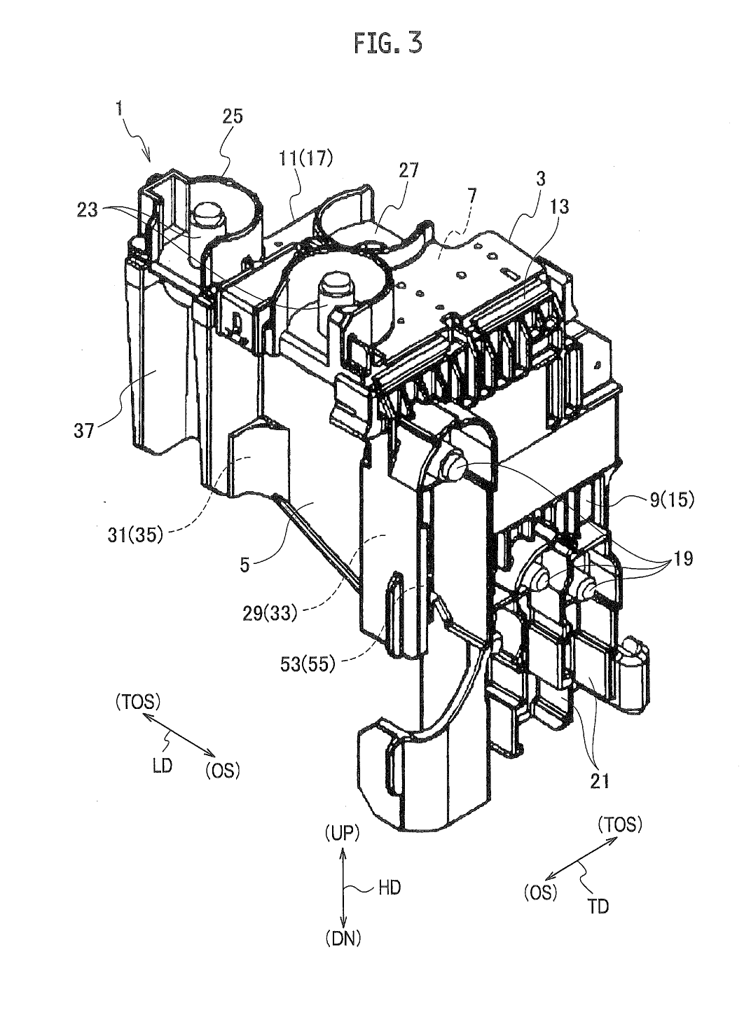

The fuse unit body 3 includes a fuse element (bus bar) 7, a first resin body 9, and a second resin body 11 as illustrated, for example, in FIG. 3.

The fuse element 7 is a thin plate-shaped conductive material, such as a metal, which is formed into a predetermined shape. A hinge (bent portion) 13 is provided in the middle part of the conductive fuse element 7. The hinge 13 linearly extends in a predetermined direction (lateral direction) perpendicular to the thickness direction of the material.

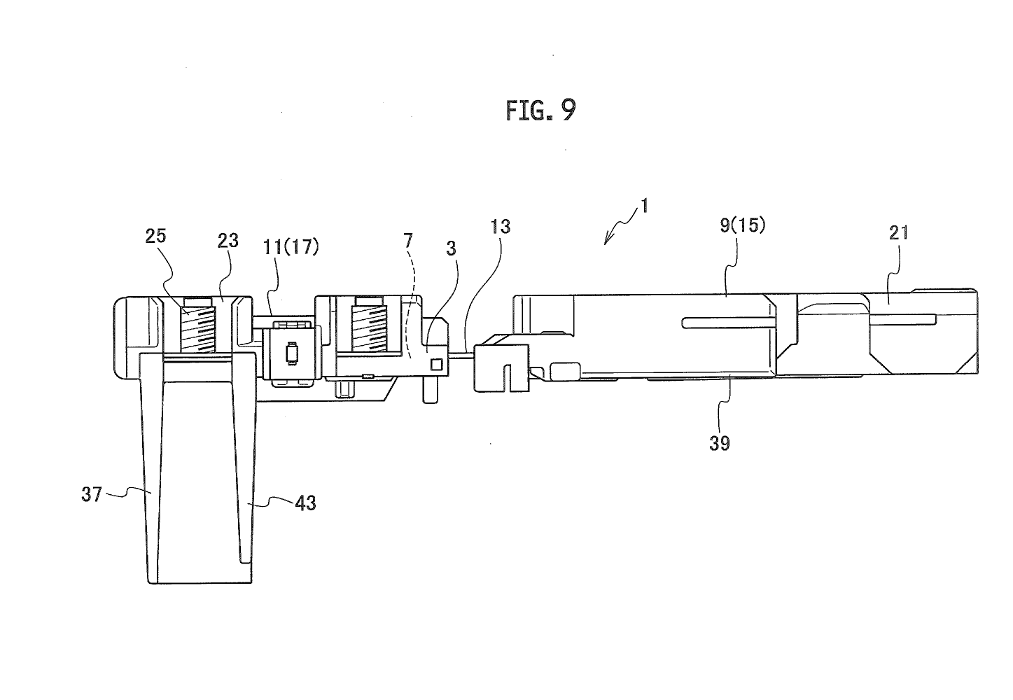

As illustrated, for example, in FIG. 3 and FIG. 9, a first resin body 9 is integrally provided with a first side of the fuse element 7 while the hinge 13 is regarded as a boundary (gap). The first resin body 9 is, for example, a slight distance away from the hinge 13 and covers a part of the fuse element 7. The first resin body 9 is provided to the fuse element 7, for example, by insert molding.

A second resin body 11 is integrally provided with a second side of the fuse element 7 while the hinge 13 is regarded as a boundary (gap). Similarly to the first resin body 9, the second resin body 11 is, for example, a slight distance away from the hinge 13 and covers a part of the fuse element 7. The second resin body 11 is also provided to the fuse element 7, for example, by insert molding.

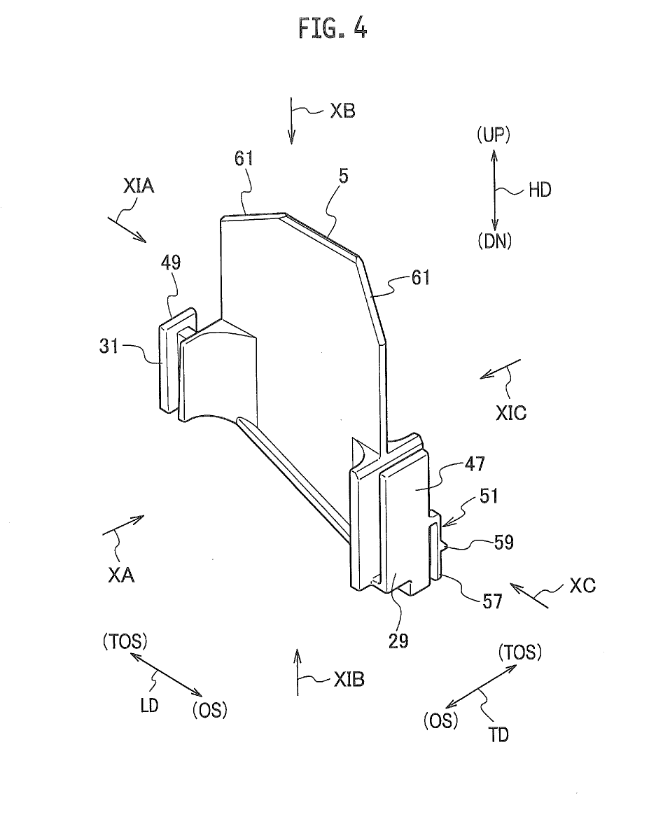

As illustrated, for example, in FIG. 4, the bent-state holding member 5 is a different member from the fuse unit body 3 in such a way as to be attached to and removed from the fuse unit body 3. As illustrated, for example, in FIG. 5, the bent-state holding member 5 is engaged with the first resin body 9 and the second resin body 11 and maintains the fuse unit body 3 in a bent state (the bent state of the fuse unit body 3) when the fuse unit body 3 is bent at a predetermined angle, for example, at a 90 degree (when the fuse unit body 3 is in a bent state) at the hinge 13 (the line on which the hinge 13 is bent).

The fuse unit body 3 includes a first portion 15 and a second portion 17. The first portion 15 has a plate (flat plate) shape with a predetermined thickness (a first thickness). The first portion 15 is formed by a portion on the first side of the fuse element 7 divided by the hinge 13 regarded as a boundary, and the first resin body 9 (for example, a part of the first resin body 9). As illustrated, for example, in FIG. 3, the first portion 15 is provided with terminals 19 and ribs 21. However, when the terminals 19 and ribs 21 are removed, the first portion 15 has a nearly flat plate shape.

The second portion 17 has a plate (flat plate) shape with a predetermined thickness (a second thickness). The second portion 17 is formed by a portion on the second side of the fuse element 7 divided by the hinge 13 regarded as a boundary, and the second resin body 11 (for example, a part of the second resin body 11). The second portion 17 is also provided with terminals 23, ribs 25, and a battery connection unit 27. However, when the terminals 23, ribs 25, and battery connection unit 27 are removed, the second portion 17 has a nearly flat plate shape.

Each of the terminals 19 and 23 is electrically connected to the battery connection unit 27 through a soluble unit (fuse unit, not illustrated) provided in the fuse element 7. Each of the terminals 19 and 23 is connected to electrical equipment installed on the vehicle through a wire (not illustrated).

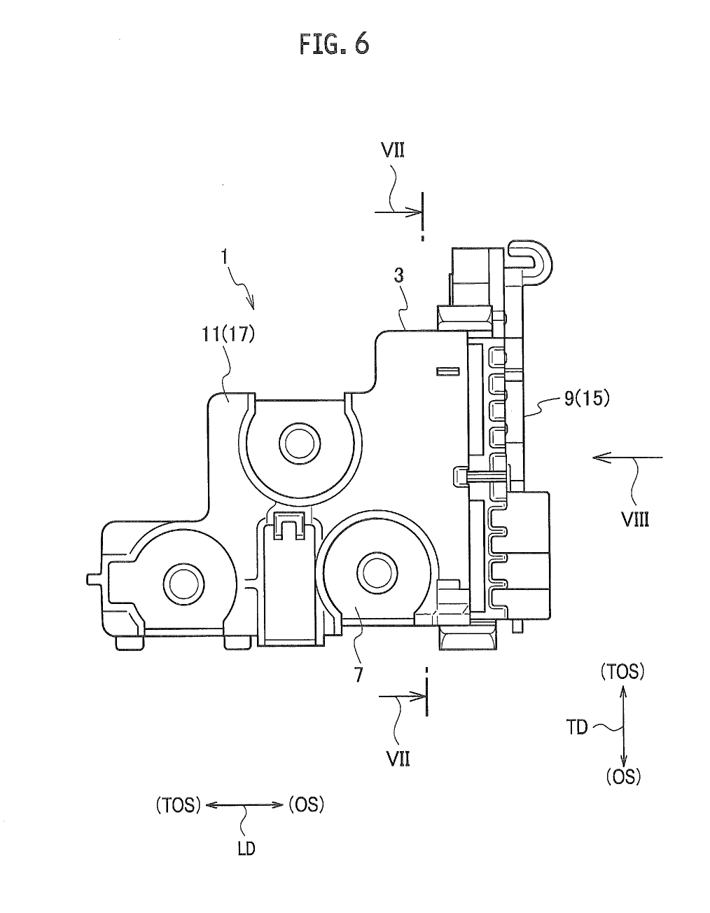

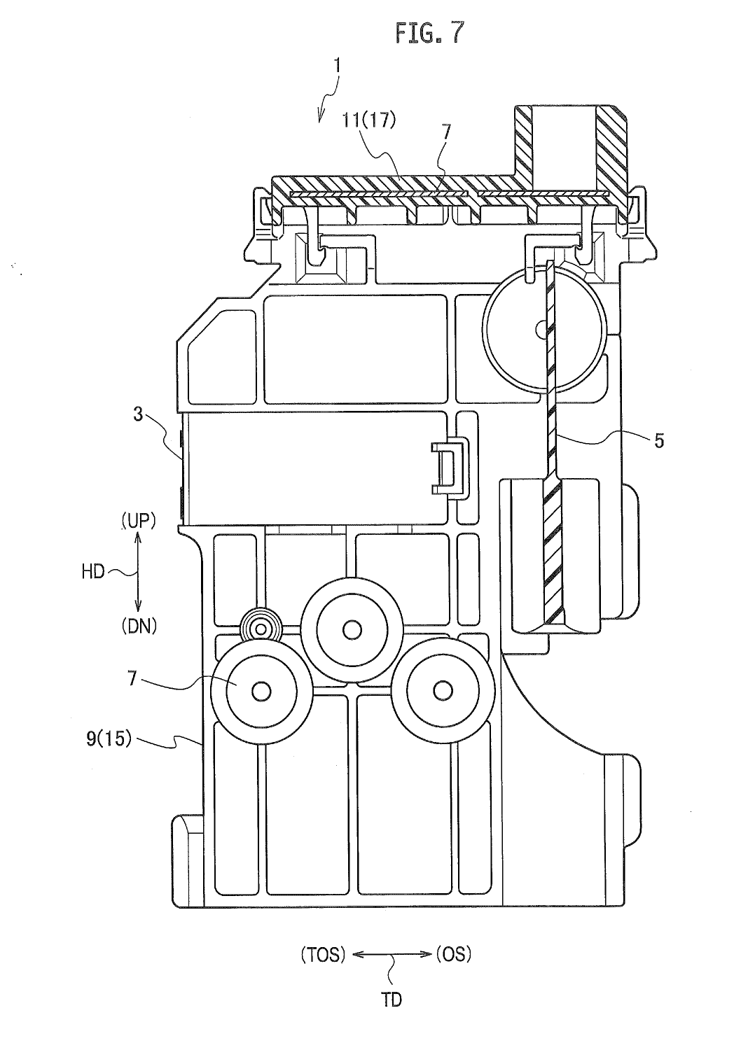

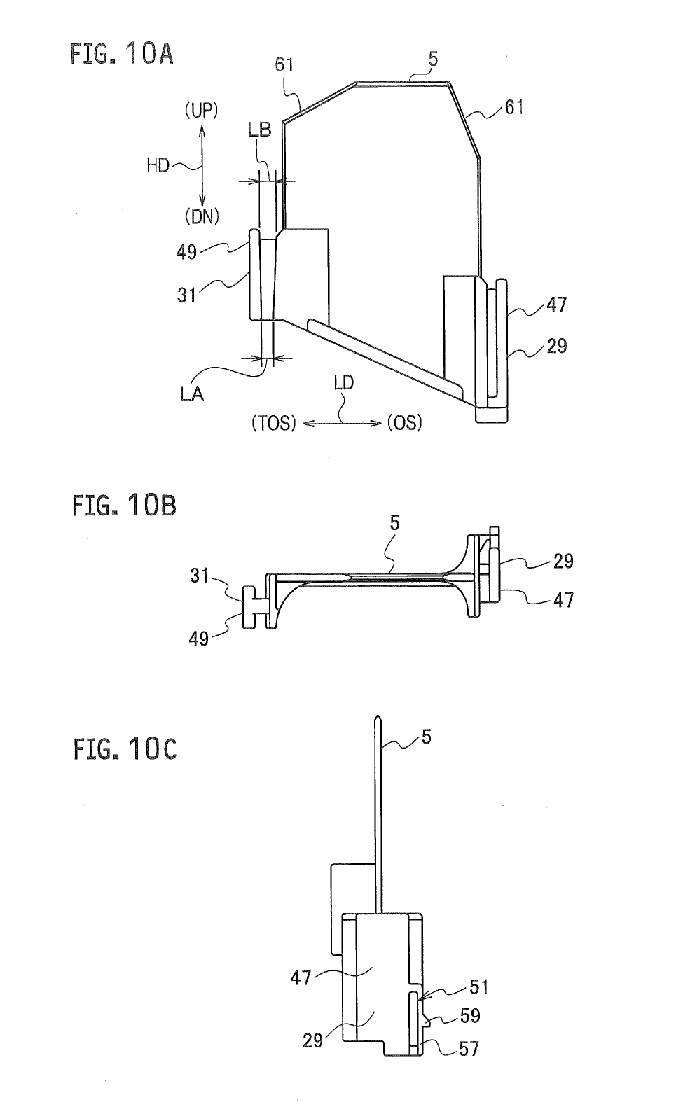

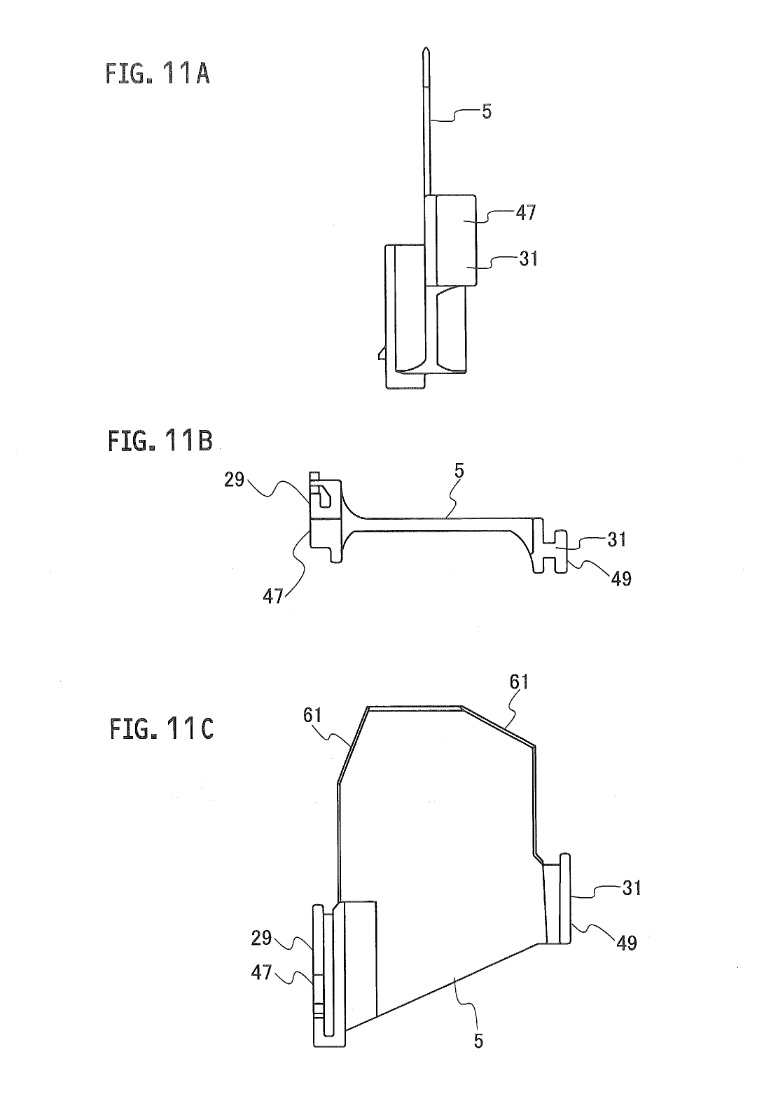

As illustrated, for example, in FIG. 4, FIGS. 10A to 10C, and FIGS. 11A to 11C, the bent-state holding member 5 is formed into a flat plate shape with a predetermined thickness (a third thickness). When the bent-state holding member 5 holds the fuse unit body 3 which is bent at the hinge 13 (the fuse unit body 3 is maintained in a bent state), as illustrated in FIGS. 5 to 8, the directions of the predetermined thickness of the first portion 15 (the first thickness), the predetermined thickness of the second portion 17 (the second thickness), and the predetermined thickness of the bent-state holding member 5 (the third thickness) are perpendicular to each other (or can intersect with each other at an angle approximate to 90° between 70 and 110°).

When the state in which the fuse unit body 3 is maintained in the bent state is viewed in the direction in which the hinge 13 extends (the lateral direction), the first portion 15 and the second portion 17 form an L shape. The bent-state holding member 5 is engaged with and fixed on the first portion 15 and the second portion 17 at a part on the side of the minor angle of the intersection angles of the first portion 15 and the second portion 17.

Accordingly, the bent-state holding member 5 roughly fills a part that is a quadrant on the minor angle among the intersection angles of the first portion 15 and the second portion 17. Meanwhile, the bent-state holding member 5 is located near a first end in the direction in which the hinge 13 extends (the lateral direction). In other words, in the state in which the fuse unit body 3 is maintained in the bent state, the first portion 15, the second portion 17, and the bent-state holding member 5 have a relationship similar to the relationship among three planes developing from an angle of a cuboid and perpendicular to each other.

In the state in which the fuse unit body 3 is maintained in the bent state, the thickness direction of the plate-shaped first portion 15 is the longitudinal direction (a predetermined direction perpendicular to the lateral direction), the thickness direction of the plate-shaped second portion 17 is the height direction (a predetermined direction perpendicular to the lateral direction and the longitudinal direction), and the thickness direction of the plate-shaped bent-state holding member 5 is the lateral direction.

Both of the first resin body 9 and the second resin body 11 are made of synthetic resin having non-conductivity and heat resistance. The bent-state holding member 5 is also made of synthetic resin having non-conductivity and heat resistance.

The fuse unit 1 in which the fuse unit body 3 is maintained in the bent state is installed and used on the battery, for example, of a car. When the fuse unit 1 is installed on a cubic battery, the fuse unit 1 covers an upper corner of the battery and the three planes developing from the upper corner (a part of the upper surface, a part of the first side surface, and a part of the second side surface of the battery).

As illustrated, for example, in FIG. 4, FIGS. 10A to 10C, and FIGS. 11A to 11C, the bent-state holding member 5 includes a first engaged portion 29 and a second engaged portion 31. The first resin body 9 of the fuse unit body 3 is provided with a first engaging portion 33 with which the first engaged portion 29 of the bent-state holding member 5 is engaged. The second resin body 11 is provided with a protruding portion 37 protruding to the same side as the first portion 15. The protruding portion 37 is provided with a second engaging portion 35 with which the second engaged portion 31 of the bent-state holding member 5 is engaged.

The first engaged portion 29 of the bent-state holding member 5 is engaged with the first engaging portion 33 of the first resin body 9. The second engaged portion 31 of the bent-state holding member 5 is engaged with the second engaging portion 35 provided on the second resin body 11. Linearly moving the bent-state holding member 5 in the thickness direction of the second portion 17 (the height direction) installs and fixes the bent-state holding member 5 on the fuse unit body 3.

The first engaging portion 33 includes a plate-shaped portion (a first plate-shaped portion) 39 and an elongated notch formed on the plate-shaped portion 39 (a first notch penetrating the plate-shaped portion 39 in the thickness direction, and not illustrated). The second engaging portion 35 includes a plate-shaped portion (a second plate-shaped portion) 43 and an elongated notch formed on the plate-shaped portion 43 (a second notch penetrating the plate-shaped portion 43 in the thickness direction, and not illustrated).

The first engaged portion 29 is a portion (first H-shaped portion) 47 of which cross-sectional surface, which is a plane perpendicular to the longitudinal direction (the height direction), has an H shape. The second engaged portion 31 is a portion (second H-shaped portion) 49 of which cross-sectional surface, which is a plane perpendicular to the longitudinal direction (the height direction), has an H shape.

The horizontal line of the H shape of the first engaged portion 29 is inserted into the notch (not illustrated) of the first engaging portion 33. The plate-shaped portion 39 of the first engaging portion 33 is placed between a pair of the vertical lines of the H shape of the first engaged portion 29. This engages the first engaged portion 29 with the first engaging portion 33.

Furthermore, the horizontal line of the H shape of the second engaged portion 31 is inserted into the notch (not illustrated) of the second engaging portion 35. The plate-shaped portion 43 of the second engaging portion 35 is placed between a pair of the vertical lines of the H shape of the second engaged portion 31. This engages the second engaged portion 31 with the second engaging portion 35.

The bent-state holding member 5 linearly moves to the fuse unit body 3 in the longitudinal direction of each of the notches (not illustrated) and in the longitudinal direction of each of the H-shaped portions (the bent-state holding member 5 linearly moves upward in the height direction). This installs and fixes the bent-state holding member 5 on the fuse unit body 3.

The distance between the pair of the vertical lines of the H shape of the second engaged portion 31 is increased on the side that is first engaged with the second engaging portion 35 (the upper side), and is gradually decreased toward the side that is last engaged with the second engaging portion 35 (the lower side) when the bent-state holding member 5 is moved and fixed on the fuse unit body 3.

In other words, the distance between the pair of the vertical lines of the H shape of the second engaged portion 31 gradually increases in the direction of movement of the bent-state holding member 5 when the bent-state holding member 5 is fixed on the fuse unit body 3. In other words, a dimension LB is larger than a dimension LA illustrated in FIG. 10A.

The first engaged portion 29 is provided on a first longitudinal end of the bent-state holding member 5. The second engaged portion 31 is provided on a second longitudinal end of the bent-state holding member 5.

In the state in which the fuse unit body 3 is maintained in the bent state, the first resin body 9 and the second resin body 11 are connected through the bent-state holding member 5 in addition to the hinge 13. The first resin body 9, the second resin body 11, and the bent-state holding member 5 are integrated with each other. This maintains the state in which the fuse unit body 3 is bent. In other words, the angle at which the hinge 13 is bent is maintained at a constant value (for example, 90°).

A seized portion (the seized portion of the bent-state holding member) 51 is provided on the first longitudinal end of the bent-state holding member 5. The first resin body 9 is provided with a seizing portion (the seizing portion of the bent-state holding member) 53 with which the seized portion 51 of the bent-state holding member 5 is engaged and seized.

When the bent-state holding member 5 is installed and fixed on the fuse unit body 3, seizing the seized portion 51 on the seizing portion 53 prevents the bent-state holding member 5 from falling. In other words, when the bent-state holding member 5 is installed and fixed on the fuse unit body 3, the bent-state holding member 5 is prevented from moving (moving downward) in the direction opposite to the direction in which the bent-state holding member 5 is moved (upward) and installed on the fuse unit body 3.

The seizing portion 53 can be provided on the second resin body 11 instead of or in addition to being provided on the first resin body 9. In such cases, the seized portion 51 is also provided on the second longitudinal end of the bent-state holding member 5, relative to the seizing portion 53.

Alternatively, a seizing portion (a first portion seizing portion different from the seizing portion 53) is provided on the first portion 15 (for example, the first resin body 9) of the fuse unit body 3, and a seized portion (a second portion seized portion different from the seized portion 51) is provided on the second portion 17 (for example, the second resin body 11) of the fuse unit body 3. When the fuse unit body 3 is bent at the hinge 13, the second portion seized portion is seized on the first portion seizing portion. This may enable the fuse unit body 3 to maintain the bent state of the L shape without the bent-state holding member 5.

Instead of or in addition to that the distance between the pair of the vertical lines of the H shape of the second engaged portion 31 changes as described above, the distance between the pair of the vertical lines of the H shape of the first engaged portion 29 can also be increased on the upper side and is gradually decreased toward the lower side, similarly to the second engaged portion 31.

In the state in which the fuse unit body 3 is maintained in the bent state, the thickness direction of the first portion 15 of the L-shaped fuse unit body 3 is the longitudinal direction as illustrated, for example, in FIG. 5. The linear hinge 13 extends in the lateral direction on the upper end of the first portion 15. The thickness direction of the second portion 17 of the L-shaped fuse unit body 3 is the height direction. The second portion 17 extends from the hinge 13 to the longitudinal other end.

The first engaging portion 33 is formed on the lateral one end of the first resin body 9. The thickness direction of the plate-shaped portion 39 of the first engaging portion 33 is the longitudinal direction. The notch (not illustrated) of the plate-shaped portion 39 has an opening on the lower end of the plate-shaped portion 39, and has a U shape that extends upward from the lower end of the plate-shaped portion 39.

The seizing portion 53 is formed by the protrusion 55. The protrusion 55 is provided on the lower end of the plate-shaped portion 39 near the notch (not illustrated) of the plate-shaped portion 39. The protrusion 55 protrudes from a first surface in the thickness direction of the plate-shaped portion 39 (the surface on the longitudinal one end), and is located more nearly to the lateral other end than to the notch (not illustrated).

The protruding portion 37 is formed integrally with the second resin body 11. The protruding portion 37 is located on the lateral one end of the second portion 17 and on the longitudinal other end of the second portion 17. The protruding portion 37 protrudes downward from the first side (lower side) in the thickness direction of the second portion 17 and along the first portion 15, having a distance away from the first portion 15.

The thickness direction of the plate-shaped portion 43 of the protruding portion 37 is also the longitudinal direction. The notch (not illustrated) of the plate-shaped portion 43 also has an opening on the lower end of the plate-shaped portion 43, and has a U shape that extends upward from the lower end of the plate-shaped portion 43.

The plate-shaped portion 39 and the notch (not illustrated), and the plate-shaped portion 43 and the notch (not illustrated) form a guide rail that guides the bent-state holding member 5 engaging with the fuse unit body 3 and moving in the height direction.

In the state in which the fuse unit body 3 is maintained in the bent state, the thickness direction of the plate-shaped bent-state holding member 5 is the lateral direction. The first engaged portion 29 is provided on the longitudinal one end on the lower end of the bent-state holding member 5. The thickness directions of the portions that are the pair of the vertical lines of the H shape of the first engaged portion 29 are the longitudinal direction. The second engaged portion 31 is provided on the longitudinal other end on the lower end of the bent-state holding member 5. The thickness directions of the portions that are the pair of the vertical lines of the H shape of the second engaged portion 31 are also the longitudinal direction.

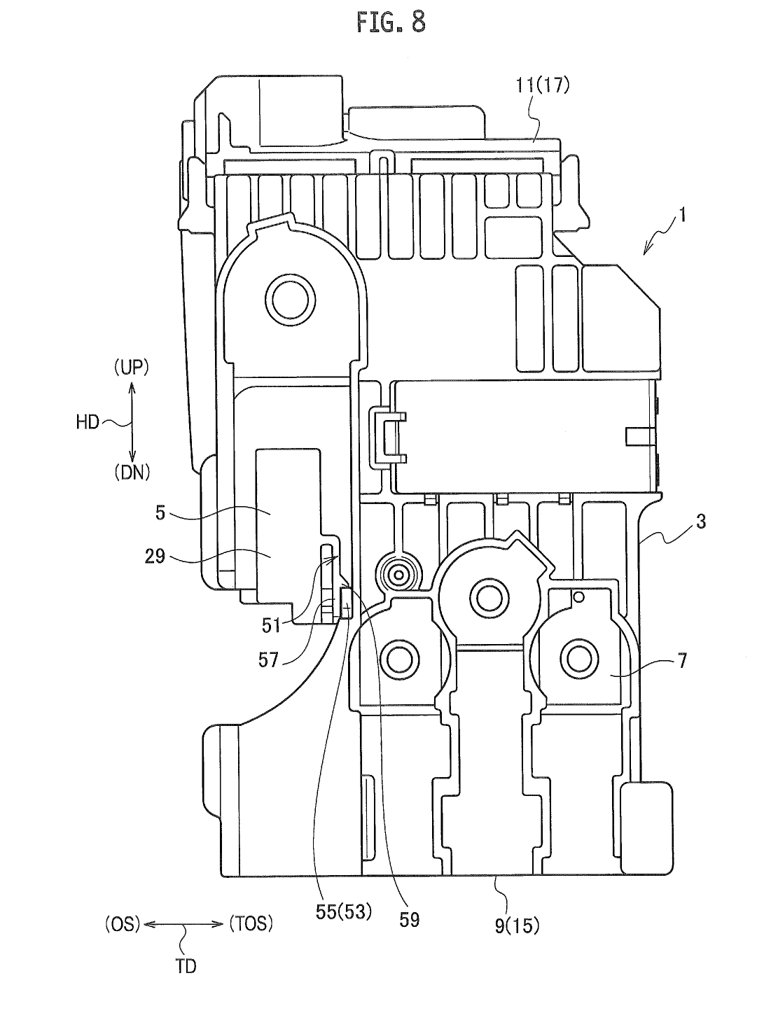

As illustrated, for example, in FIG. 10C, the seized portion 51 of the bent-state holding member 5 includes an elastic arm 57 and a protrusion 59. In the middle of the installation of the bent-state holding member 5 on the fuse unit body 3, the protrusion 59 of the seized portion 51 comes into contact with the protrusion 55 of the seizing portion 53 and this makes the elastic arm 57 elastically deformed. After the completion of the installation of the bent-state holding member 5 on the fuse unit body 3, the elastic arm 57 is restored, and the protrusion 59 of the seized portion 51 is in contact with the protrusion 55 of the seizing portion 53. This prevents the bent-state holding member 5 from falling (see FIG. 8).

Note that, although the elastic arm 57 is a double-supported beam, the elastic arm 57 can be a cantilever.

As illustrated, for example, in FIG. 5, the upper side of the bent-state holding member 5 has two C-chamfered sides 61 that are chamfered parts. The two C-chamfered sides 61 can be removed or minimized so that the triangle voids 63 can be prevented from being formed as illustrated in FIG. 5 in the state in which the fuse unit body 3 is maintained in the bent state.

A process for forming the fuse unit 1 in which the fuse unit body 3 is maintained in the bent state will be described next.

First, the fuse unit body 3 that is not bent at the hinge 13 (see FIG. 9) is bent at a right angle at the hinge 13 (see FIG. 3).

Next, the bent-state holding member 5 is moved upward from below the fuse unit body 3 bent at the hinge 13. The first engaged portion 29 is engaged with the first engaging portion 33. The second engaged portion 31 is engaged with the second engaging portion 35. Meanwhile, the bent-state holding member 5 is moved further upward to the fuse unit body 3. This makes the elastic arm 57 elastically deformed.

Moving the bent-state holding member 5 further upward restores the elastic arm 57 while the first engaged portion 29 is engaged with the first engaging portion 33 and the second engaged portion 31 is engaged with the second engaging portion 35. This seizes the seized portion 51 on the seizing portion 53.

In the fuse unit 1, the bent-state holding member 5 formed by a different member from the fuse unit body 3 maintains the state in which the fuse unit body 3 is bent at the hinge 13. Thus, it is unnecessary to provide a long elastic arm as the engaged portion. This prevents the fuse unit 1 from increasing in size. Furthermore, the engaged portion made of a brittle material is not required. This can prevent the holding force to maintain the bent shape from varying.

In the fuse unit 1, the bent-state holding member 5 is formed as a different body. The seizing portion and the seized portion are not integrally provided on the resin bodies 9 and 11, respectively. This makes it unnecessary to adjust the margin for the engagement of the seizing portion and the seized portion.

In the related fuse unit, the short seized portion made of a hard brittle material is elastically deformed. Thus, when the operations: to seize the seized portion on the engaging portion; to release the seizing of the seized portion on the seizing portion; and to seize the seized portion on the engaging portion are repeated several times, this repetition can adversely cause the seized portion, for example, to be fatigued or be broken. On the other hand, the fuse unit 1 according to the present embodiment can avoid the occurrence of such failures if the installation and removal of the bent-state holding member 5 are repeated.

When the state in which the fuse unit body 3 is maintained in the bent state in the fuse unit 1, the thickness direction of the first portion 15, the thickness direction of the second portion 17, and the thickness direction of the bent-state holding member 5 are perpendicular to each other. The first portion 15 and the second portion 17 form an L shape. The bent-state holding member 5 is engaged with the first portion 15 and the second portion 17 at a part on the side of the minor angle of the intersection angles of the first portion 15 and the second portion 17. Thus, the bent-state holding member 5 blocks the opening between the first portion 15 and the second portion 17 (the first lateral side). This makes the bent-state holding member 5 work as an insulting protective wall.

In other words, when the fuse unit 1 is installed on a battery, the bent-state holding member 5 exists between the wires extending from the terminals of the fuse unit 1 and the battery in such a way as to work as an insulting protective wall.

In the fuse unit 1, the bent-state holding member 5 linearly moves in the height direction. This installs and fixes the bent-state holding member 5 on the fuse unit body 3. This makes it easy to install the bent-state holding member 5 on the fuse unit body 3. Even if the fuse unit 1 is placed in a small space, the bent-state holding member 5 can easily be installed on the fuse unit body 3.

In the fuse unit 1, the distance between the pair of the vertical lines of the H shape of the second engaged portion 31 is increased on the upper side and is gradually deceased toward the lower side. This enables the bent-state holding member 5 to slightly change its posture (the rotational angle around the shaft extending in the lateral axis direction) while the bent-state holding member 5 is installed on the fuse unit body 3. This makes it easier to install the bent-state holding member 5 on the fuse unit body 3.

In this way, the present invention includes various embodiments not described above. Therefore, the scope of the present invention is determined only by the invention identification matters according to claims reasonable from the foregoing description.

What is claimed is:

1. A fuse unit comprising:
a fuse unit body including
a conductive fuse element having a hinge, the fuse unit body being bendable at the hinge,
a first resin body provided on a first side of the fuse element across the hinge, and
a second resin body provided on a second side of the fuse element, the second side located opposite to the first side across the hinge; and
a holding member being a different member from the fuse unit body, engaging with the first resin body and the second resin body of the fuse unit body bent at the hinge, and maintaining the fuse unit body in a bent state, wherein
the fuse unit body comprises
a first portion having a plate shape with a first thickness including a portion on the first side of the fuse element and the first resin body, and
a second portion having a plate shape with a second thickness including a portion on the second side of the fuse element and the second resin body,
the holding member has a plate shape with a third thickness, and
upon the bent state of the fuse unit body being maintained by the holding member, a thickness direction of the first thickness, a thickness direction of the second thickness, and a thickness direction of the third thickness are perpendicular to each other, the first portion and the second portion form an L shape when viewed in a direction in which the hinge extends, and the holding member is engaged with the first portion and the second portion at a portion at a minor angle of intersection angles of the first portion and the second portion.

2. The fuse unit according to claim 1, wherein
the holding member includes a first engaged portion and a second engaged portion,
the first resin body includes a first engaging portion with which the first engaged portion engages,
the second resin body includes a protrusion portion protruding in a direction identical to a direction in which the first portion extends and including a second engaging portion with which the second engaged portion engages, and
the holding member is fixed on the fuse unit body with the first engaged portion engaged with the first engaging portion, the second engaged portion engaged with the second engaging portion, and the holding member linearly moved in the thickness direction of the second thickness.

3. The fuse unit according to claim 2, wherein
the first engaging portion includes a first plate-shaped portion and an elongated first notch on the first plate-shaped portion,
the second engaging portion includes a second plate-shaped portion and an elongated second notch on the second plate-shaped portion,
the first engaged portion includes a portion having a cross-section of an H shape,
the second engaged portion includes a portion having a cross-section of an H shape,
the first engaged portion engages with the first engaging portion with a portion that is a horizontal line of the H shape of the portion of the first engaged portion being inserted into the first notch and with portions that are a pair of vertical lines of the H shape of the portion of the first engaged portion holding the first plate-shaped portion between the vertical lines,
the second engaged portion engages with the second engaging portion with a portion that is a horizontal line of the H shape of the portion of the second engaged portion being inserted into the second notch and with portions that are a pair of vertical lines of the H shape of the portion of the second engaged portion holding the second plate-shaped portion between the vertical lines,
the holding member is fixed on the fuse unit body with the holding member linearly moved in an insertion direction along a longitudinal direction of the first notch and the second notch and a longitudinal direction of the H-shaped portions of the first engaged portion and the second engaged portion, and
a distance between the pair of vertical lines of the H shape of the portion of the second engaged portion is gradually decreased toward the insertion direction.
